(19) United States
(12) Patent Application Publication
(10) Pub. No.: US 2008/0033795 A1
(43) Pub. Date: Feb. 7, 2008

(54) System and Method for Distributing Advertising Content

(75) Inventors: Judd Wishnow, Brooklyn, NY (US); Michael O. Glaser, Syosset, NY (US)

Correspondence Address: PLUMSEA LAW GROUP, LLC, 10411 MOTOR CITY DRIVE, SUITE 320, BETHESDA, MD, 20817, US

(73) Assignee: The Panel Group, LLC, Great Neck, NY (US)

(21) Appl. No.: 11/458,959

(22) Filed: Jul. 20, 2006

(51) Int. Cl. G06Q 30/00

(52) U.S. Cl. 705/14

(57) ABSTRACT

A system and method for distributing advertising content. The system includes a central unit capable of communicating with one or more remote systems. The remote systems may be amusement devices, and each one may be associated with a particular venue. The method for distributing advertising content comprises receiving registration information from an advertiser, receiving advertising content from the advertiser, receiving at least one advertising preference from the advertiser, and distributing the advertising content to at least one remote system based on the advertising preferences.

### BACKGROUND OF THE INVENTION

1. Field of the Invention

The present invention relates generally to distributing content, and more particularly to systems and methods for distributing multimedia content including advertising content.

2. Description of Related Art

Amusement devices, such as jukeboxes, video games, and media players, have long been found in bars, restaurants, and other public gathering places. As one example, the classic jukebox of the 1950s was stocked with a number of 45 rpm records, each of which held a song or songs, and the user could listen to any one of those records on demand by paying a certain amount of money. In later years, 45 rpm records were replaced by compact discs.

As technologies have improved, so have amusement devices. Many of today's amusement devices are essentially specially configured computer systems. For example, a typical modern electronic jukebox may have thousands of songs stored on a local hard disk drive, and may communicate with a central server to retrieve songs that are not stored on the local hard disk drive. Meanwhile, video games and sport-activity amusement devices immerse the user in ever more realistic computer-generated gaming and sport environments.

Despite the improvements in technology, the fundamental manner of operation of amusement devices has not changed. Typically, the user completes some type of purchase transaction and is then allowed to use the amusement device for a limited period of time or for a limited purpose. The owner or operator of the amusement device typically profits by collecting the proceeds from the user transactions.

### SUMMARY OF THE INVENTION

A system and method for distributing advertising content are disclosed. The terms “advertising” and “advertising content,” as used throughout the specification and claims, refer to video, audio, picture, or interactive content that promotes or provides information about a particular viewpoint, brand, product, service, company, or organization. In preferred embodiments, the system includes remote units placed in particular venues. The term “venue,” as used throughout the specification and claims, refers to any location in which the delivery of advertising content is desirable.

In one aspect, the invention provides a method for distributing advertising content. The method comprises the steps of receiving registration information from an advertiser, receiving advertising content from the advertiser, receiving at least one advertising preference from the advertiser, and distributing the advertising content to at least one amusement device based on the advertising preferences.

In another aspect, the registration information is received using an interactive interface.

In another aspect, the advertising content includes video.

In another aspect, the advertising content includes audio.

In another aspect, the advertising content is a still image.

In another aspect, the advertising content includes animation.

In another aspect, the advertising preference is related to a geographic location.

In another aspect, the advertising preference is related to a demographic criteria.

In another aspect, the advertising preference is related to venue information.

In another aspect, the invention provides a method for distributing advertising content. The method comprises the steps of receiving an advertisement and at least one advertising preference from an advertiser, distributing the advertisement to at least one amusement device in accordance with the advertising preference, and receiving payment from the advertiser based on the distribution of the advertisement.

In another aspect, the payment is automatically collected.

In another aspect, the advertising preference selects multiple amusement devices to receive the advertisement.

In another aspect, a plurality of amusement devices are associated with a demographic criteria and an advertising preference is associated with the demographic criteria.

In another aspect, a plurality of amusement devices are associated with a geographic criteria and an advertising preference is associated with the demographic criteria.

In another aspect, the invention relates to a method for interacting with an advertiser. The method comprises the steps of receiving registration information from an advertiser, receiving advertisement distribution information from at least one amusement device, and providing access to an interactive interface. The interactive interface includes advertisement distribution information received from the amusement device.

In another aspect, the advertisement distribution information includes a time when an advertisement associated with the advertiser was distributed.

In another aspect, advertisement distribution information includes location information where an advertisement associated with the advertiser was distributed.

In another aspect, the advertisement distribution information includes frequency information related to a number of times when an advertisement associated with the advertiser was distributed.

In another aspect, the advertisement distribution information includes confirmation information related to an advertisement associated with the advertiser.

In another aspect, the confirmation information includes an image of the advertisement being distributed.

In another aspect, the confirmation information includes a video of the advertisement being distributed.

In another aspect, the invention provides a method for distributing advertising content comprising the steps of receiving play list information from a remote system; determining a predominant music genre for the play list; receiving an advertisement from an advertiser; receiving a distribution preference from the advertiser associated with a music genre; and distributing the advertisement to at least one remote system based on the distribution preference and the predominant music genre for the play list.

In another aspect, a venue numerical value, assigned to a venue associated with the remote system, is determined using the predominant music genre of the play list.

In another aspect, a venue numerical value associated with a predominant music genre of the play list is determined.

In another aspect, songs of the play list have associated song genres, and wherein those song genres are assigned a song numerical value.

In another aspect, the song numerical value is used to determine the venue numerical value.

In another aspect, the venue numerical value is used to offer the advertiser a selection of possible music genres.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of a preferred embodiment of a system for distribution of advertising content according to a preferred embodiment of the invention;

FIG. 2 is a schematic diagram of a preferred embodiment of a remote unit/amusement device of the system of FIG. 1;

FIG. 3 is an elevational view of a preferred embodiment of an electronic dart game that may be part of the remote unit of FIG. 2;

FIG. 4 is a schematic diagram of a preferred embodiment of a system for distribution of advertising content according to another preferred embodiment;

FIG. 5 is a flow chart of a preferred embodiment of a general method for distributing advertising content;

FIG. 6 is a flow chart of a preferred embodiment of certain steps of the method of FIG. 5 in greater detail;

FIG. 7 is a schematic diagram of a preferred embodiment of a portion of an interactive interface allowing access to the system of FIG. 1, illustrating an exemplary account registration and payment information screen;

FIG. 8 is a schematic diagram of a preferred embodiment of a portion of an interactive interface allowing access to the system of FIG. 1, illustrating an exemplary advertising content placement screen;

FIG. 9 is a schematic diagram of a preferred embodiment of a portion of an interactive interface allowing access to the system of FIG. 1, illustrating an exemplary selection confirmation screen; and

FIG. 10 is a schematic diagram of a preferred embodiment of a portion of an interactive interface allowing access to the system of FIG. 1, illustrating an exemplary verification screen.

### DETAILED DESCRIPTION OF THE PREFERRED EMBODIMENTS

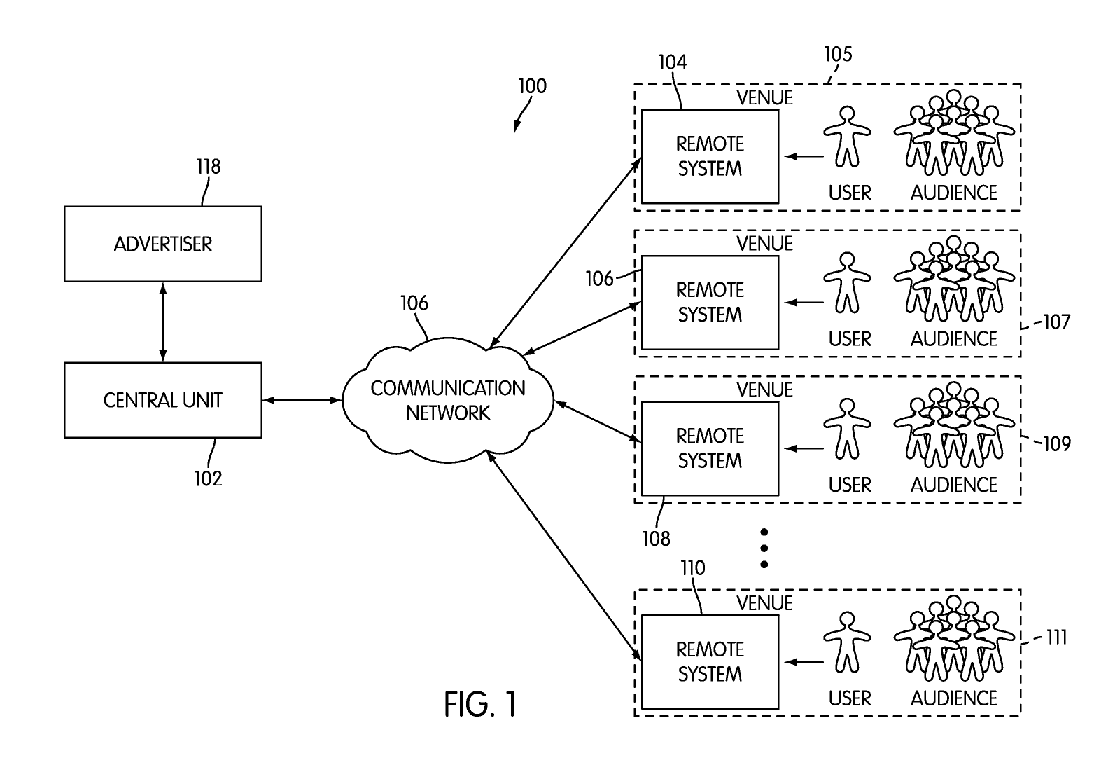

FIG. 1 is a schematic diagram of a system, generally indicated at 100, for distributing advertising content according to a preferred embodiment of the invention. System 100 comprises a central unit 102 in communication with one or more remote systems 104 through a communication network 106. Preferably, each of remote systems 104 is located in a different venue. As indicated in FIG. 1, the communication between central unit 102 and remote systems 104 is bi-directional; that is, central unit 102 may send information to remote systems 104 and remote units may send information to and update the central unit 102. Central unit 102 is also in communication with one or more advertisers 118. In some embodiments, in addition to advertisers 118, central unit 102 may also provide access and information to other parties as well.

System 100 is preferably capable of distributing entertainment, informational, or educational content along with advertising content to venues 105, 107, 109, 111 in which remote systems 104 are placed. As shown schematically in FIG. 1, a user can interact with remote system 104. In addition to the user of remote system 104, an audience can also be present at the venues 105, 107, 109 and 111. In preferred embodiments, remote systems 104 are or include amusement devices, such as music players, video players, gaming/simulation systems, or other types of devices capable of delivering content for amusement, educational, informational, or other purposes. For example, remote system 104 may include the functionality of a jukebox, a movie player, and/or a gaming system, depending on the embodiment.

Unlike classic jukeboxes, movie players, and gaming systems, system 100 can also distribute—and collect revenue—from advertising displayed along with the other content. Thus, as will be described below in greater detail, system 100 allows for two distinct revenue streams: revenue from users in exchange for the play or display of desired content, and revenue from advertisers in exchange for displaying advertising content along with the other content. Those two revenue streams are in addition to any revenues that may be collected from selling or renting remote systems 104.

Examples of venues 105 include restaurants, bars, clubs, stores, arcades, shopping malls, and other public and private spaces conducive to the placement of remote systems 104. The other content distributed by remote systems 104 may be, for example, music, videos or movies, photographs and still images, animation, and interactive/gaming content. The advertising content distributed by central unit 102 to remote systems 104 may comprise, for example, audio, video, photographs or other still images, and animation.

Preferably, remote systems 104 are installed in their respective venues 105 such that their advertising and other content can be viewed, listened to, or otherwise perceived by users, as indicated in FIG. 1. In a preferred embodiment, users can use remote systems 104 to select desired pieces of content for play, display, or presentation. For example, in one preferred embodiment, remote system 104 includes the functionality of a conventional jukebox, and users are able to select desired songs or other content for play, typically in exchange for some amount of money. Content that is not stored locally on remote system 104 may be retrieved from central unit 102 using communication network 106. Preferably, each remote system 104 has a unique identifier, such as a serial number, that is used to identify it when it communicates with the central unit 102.

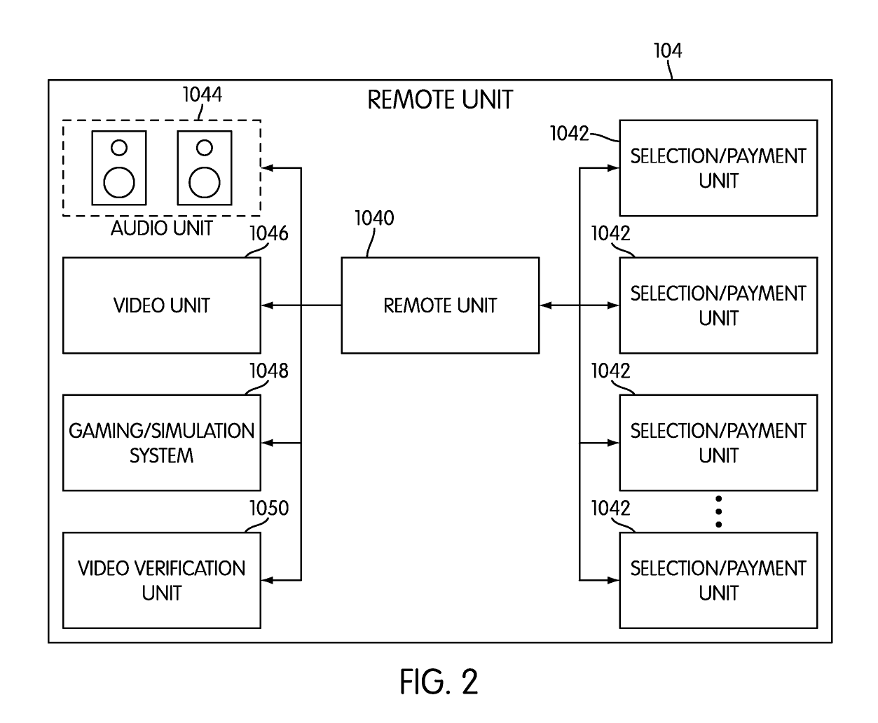

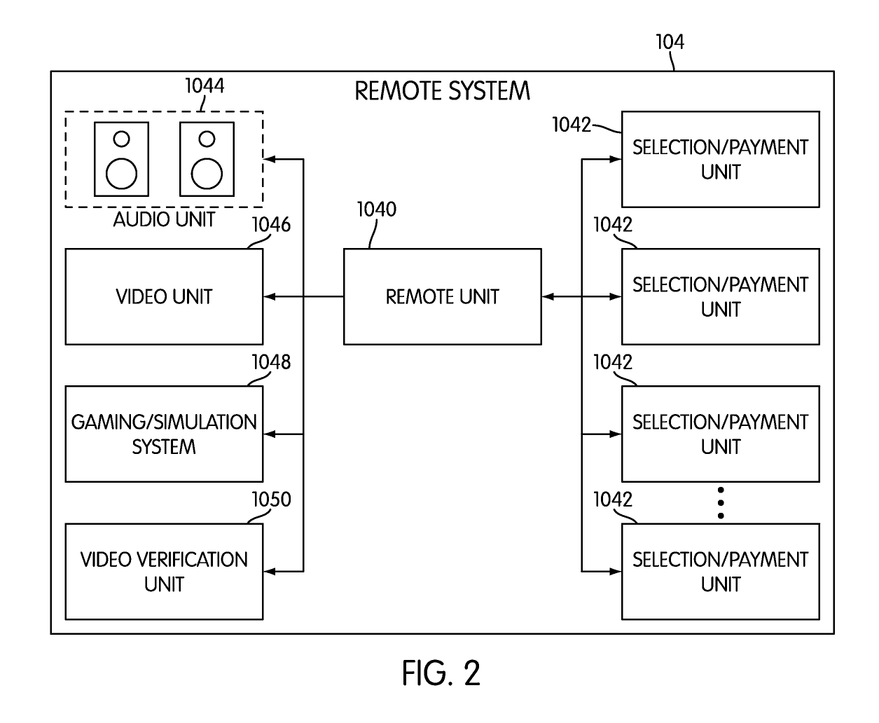

The features of any one remote system 104 can vary from embodiment to embodiment. However, FIG. 2 is a schematic diagram of the components of remote system 104 in one generalized embodiment. As shown in FIG. 2, remote system 104 can comprise one or more of the following optional devices or features: remote unit 1040, one or more selection/payment units 1042, an audio unit 1044, a video unit 1046, a gaming/simulation system 1048, and a video verification unit 1050. Again, all of these devices or features are optional. Some embodiments may include one or several of these devices or features, while other embodiments will include all of the devices or features. Different embodiments may include different devices or features.

The remote unit 1040 stores the advertising and the other content of the remote system 104, and is responsible for playing or displaying that content. The selection/payment units 1042 provide users with the ability to select and pay for the display or playback of desired content. In some embodiments, there may be only a single selection/payment unit 1042. In other embodiments, multiple selection/payment units 1042 are provided in venue 105. Audio unit 1044 and, if present, video unit 1046 and gaming/simulation system 1048 are used to play or display the content. The optional video verification unit 1050 is capable of photographing, videographing or otherwise documenting or capturing what the remote system 104 is playing or displaying, so that verification of play or display can be provided to advertisers 118 through the central unit 102. This will be described below in greater detail.

Remote unit 1040 may be a computer. The term “computer” refers to any electronic device or portion of a device capable of carrying out the functions that are described. For example, remote unit 1040 could be a personal computer, a microprocessor, an ASIC or any other sort of device. Depending on the embodiment, the term “computer” may refer to the computing resources of a single computer or the resources of two or more computers in communication with each other.

The components of remote system 104 illustrated in FIG. 2 may be co-located in venue 105 or physically distributed around venue 105. For example, in one preferred embodiment, a single selection/payment unit 1042 and audio/video units 1044, 1046 are co-located in a single integrated unit within the venue. A second audio unit 1044 and a second video unit 1046 are located in a more central and visible location in the venue. The remote unit 1040 is itself placed in a location that is preferably accessible only to employees of venue 105, such as, behind the bar or in a secured room or closet.

In other embodiments, any configuration of the components of remote system 104 may be implemented. For example, the selection/payment unit(s) 1042 may be tablet personal computers or other such portable devices that can be distributed amongst the patrons of the venue. Only audio output 1044 or video output 1046 may be provided. Video verification unit 1050 may or may not be provided.

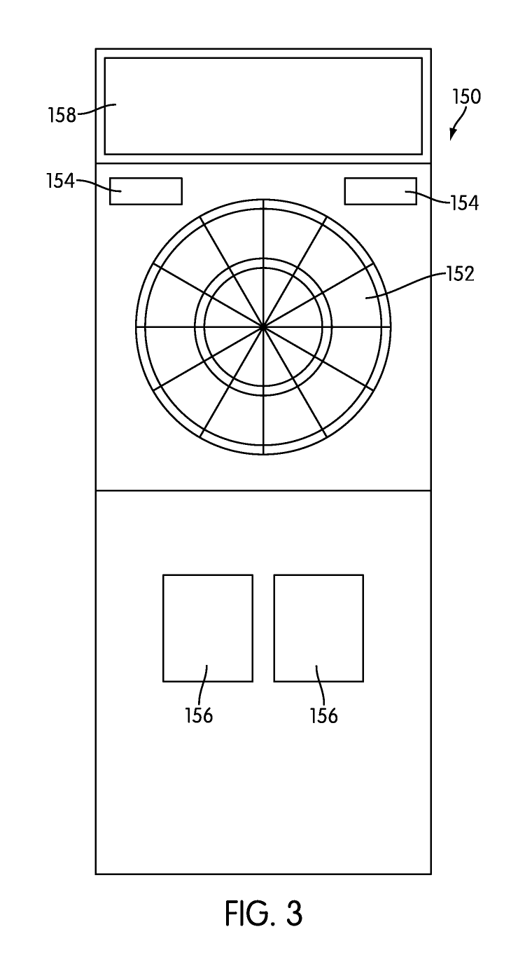

As one example of gaming/simulation system 1048, FIG. 3 is an elevational view an electronic dart game 150. Electronic dart game 150 includes a dart board 152 that registers the impact and location of darts thrown at it and, in cooperation with appropriate electronics, scores the game, score displays 154 for displaying the resulting scores, speakers 156, and a video display screen 158. Speakers 156 and video display screen 158 are coupled to remote unit 1040 to display advertising content along with the gaming prompts and content.

Central unit 102 is preferably a machine or a group of interoperating machines capable of communicating with and directing the content-delivery activities of the remote systems 104, accepting and processing advertising content from advertisers 118, and reporting the activities of the remote systems 104 to advertisers 118. Preferably, central unit 102 is a computer.

Central unit 102 may communicate with advertisers 118 and with remote systems 104 by any protocol or communication scheme known in the art. For example, in preferred embodiments, central unit 102 implements an interactive interface for advertisers 118. In one preferred embodiment, the interactive interface is a web page or series of web pages that are communicated to advertiser 118 using hypertext transfer protocol (HTTP), secure hypertext transfer protocol (HTTPS) or a virtual private network (VPN). Using the interactive interface provided by central unit 102, advertisers 118 can manage and update their accounts using the central unit 102, as will be explained below in greater detail. Communication with remote systems 104 may use any suitable network communication protocol, including TCP/IP.

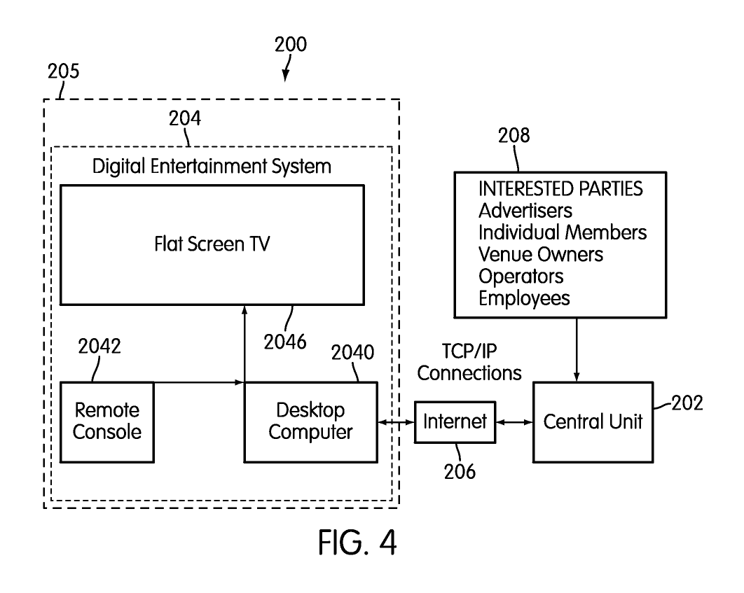

FIG. 4 is a schematic diagram of a second remote system 200 that is similar to remote system 100 and represents another preferred embodiment. In second remote system 200, a central unit 202 uses the Internet 206 to communicate with a remote unit/digital entertainment system 204 located in venue 205. Digital entertainment system 204 comprises a remote CPU that can be a desktop or notebook computer 2040, a remote console 2042 that allows a user to select and pay for content and plays the content, and a large flat screen television, projector or other large format display 2046. Typically, the computer 2040 is preferably placed where only employees of venue 205 have access to it and can operate it, while and remote console 2042 and television 2046 can be placed in locations that are plainly visible and accessible to the audience or general public in venue 205. In some embodiments, computer 2040 can be placed within remote console 2042. In system 200, central unit 202 provides access and information to a number of interested parties 208, including, for example, advertisers, individual members, venue owners, venue operators, and venue employees.

As was described above, system 200 can be used to distribute advertising content. In advertising content distribution methods according to embodiments of the invention, the uniqueness of each venue 105 is preferably taken into account. For example, each venue 105 has its own location, size, style and cuisine. These characteristics, and others, represent basic information about the venue. Additionally, each venue 105 has a particular geographic location, and is patronized by or attracts customers of a certain gender ratio, a certain average income level, particular average age ranges, and sometimes, particular ethnic ratios. Together, these characteristics and others may be referred to as a venue's demographics or demographic characteristics. In systems 100, 200 according to embodiments of the invention, central unit 102, 202 is programmed with the basic venue information and demographic characteristics of each venue, and advertisers 118, 208 are permitted to submit their advertising content along with preferences or requests as to the demographic characteristics of the venues in which that advertising content is to be displayed and/or played.

Thus, systems 100 and 200 allow not only the placement of advertising content in the venues, but also the selective placement of advertising content in specific venues based on advertiser preferences and requests. Those preferences and requests may be related to particular demographic criteria, particular geographic locations, or particular venue information. Because of this selective placement capability, the distribution of advertising content can become more efficient and effective. Specific advertisements can be targeted precisely at specific target audiences.

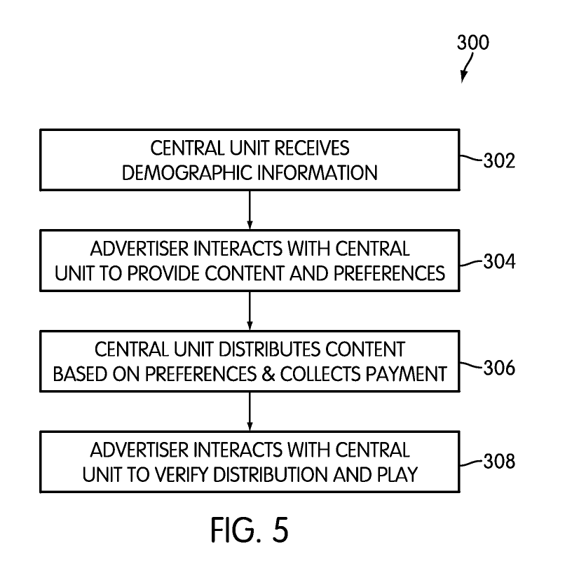

FIG. 5 is a preferred embodiment of a flow diagram of a method 300 for distributing advertising content and collecting payment for the distribution. For convenience, method 300 will be described with respect to system 100, although method 300 is equally applicable to system 200 and to other systems according to embodiments of the invention.

Method 300 begins at step 302, in which central unit 102 receives demographic characteristics and venue information for a venue 105 where a remote system 104 is located. Demographic characteristics and venue information for each venue 105 having a remote system 104 may be entered manually by an administrator of central unit 102, or some or all demographic characteristics or venue information for a particular venue 105 may be drawn from an existing demographic database or some other database or resource (not shown in the Figures).

In the description above, several examples of the ways in which venues 105 may differ were given. The total set of information associated with a particular venue 105 in central unit 102 may include essentially any characteristics of venue 105, its patrons, or the surrounding geographical area. Particular examples include:

the average consumer or patron age,

the gender ratio (male-to-female or vice-versa),

the ethnic mix,

the income level of the geographical area (by postal code or other delineator),

the style of the venue (bar, restaurant, arcade, etc.),

the capacity of the venue,

the predominant genre of music played or requested at the venue,

the food type, and

any other categories that may be suitable.

Typically, central unit 102 would associate a serial number or other unique identifier of a remote system 104 with a particular set of information on the venue, its patrons, and the surrounding geographical area, and would store the associated information on a storage medium in one or more appropriate databases. Step 302 of method 300 is repeated for each and every venue 105 in which a remote system 104 is located.

Once central unit 102 has received the demographic characteristics for each venue 105 in which a remote system 104 is located, method 300 continues with step 304. In step 304, advertiser 118 interacts with central unit 102 to provide central unit 102 with advertising content. Advertiser 118 can also provide information related to the distribution of the advertising content. In some embodiments, advertiser 118 can provide preferences and requests related to where and how that content is to be displayed. Preferably, an interactive interface accessed or used by advertiser 118 is used to assist in facilitating this interaction. However, other methods of communicating with central unit 102 may also be used. Preferred embodiments of the interaction between advertiser 118 and central unit 102 is disclosed in more detail below.

After the advertiser 118 has provided the advertising content and the preferences or requests, central unit 102 distributes the content selectively to one or more remote systems 104 based on the preferences and requests. A this point, central unit 102 can collect payment, record the transaction, or generate an invoice for advertiser 118. Preferably, the distribution process involves determining which of the remote systems 104 the content should be distributed.

In order to facilitate collection of payment in step 306, central unit 102 may require advertiser 118 to register in advance, and provide payment information before any content, preferences, or requests can be submitted. In many embodiments, payment collection will be automatic.

After step 306, method 300 continues with step 308, which, like the other steps, is optional and need not be included in all embodiments. In step 308, the advertiser interacts with central unit 102 to verify distribution of the advertising content provided by advertiser 118. As will be described below in more detail, verification of distribution is possible because remote systems 104 update central unit 102 with distribution information including confirmation information. Depending on the embodiment, confirmation information generally includes raw or modified log files and, if video verification unit 1050 is included, confirmation information may include photographs or video capturing or confirming the distribution of the advertising content.

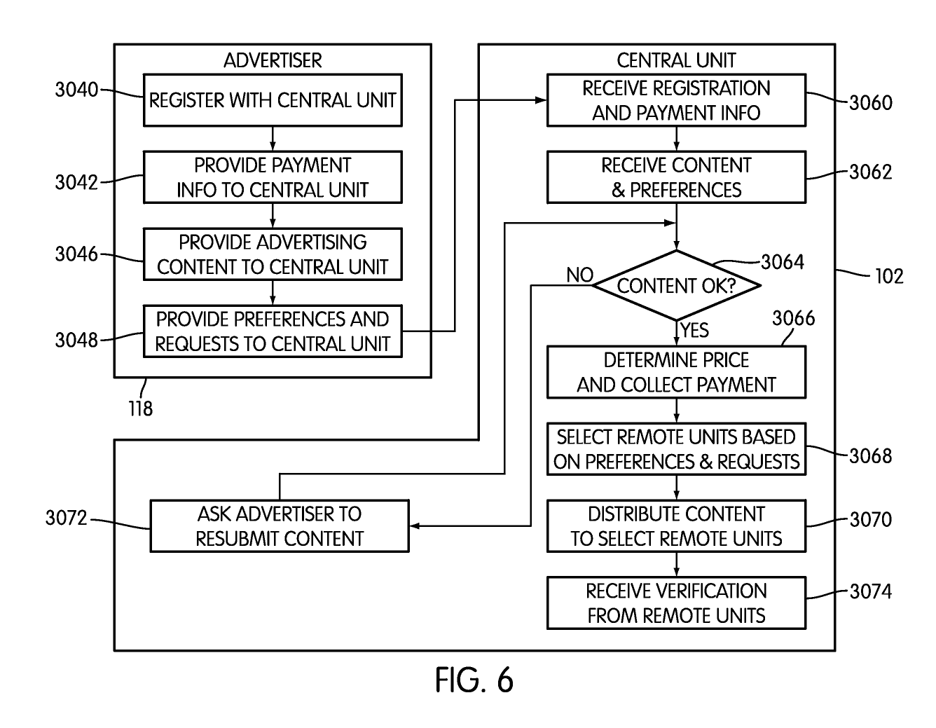

FIG. 6 is a flow chart illustrating steps 304 and 306 in more detail. FIG. 6 also generally indicates which steps or tasks are performed by advertiser 118 and which are performed by central unit 102, although the steps need not necessarily be performed as illustrated in all embodiments.

As was noted briefly above, in step 304, if advertiser 118 has not previously registered with central unit 102, step 304 begins with sub-step 3040, in which the advertiser registers with central unit 102 and provides contact and other general information to central unit 102. Step 304 also includes sub-step 3042, in which advertiser 118 provides payment information to central unit 102. These two sub-steps 3040, 3042 may be performed separately or together. For example, if “standing orders” for payment processing are to be given by advertiser 118 to central unit 102 such that payment can be collected automatically, then payment information may be collected along with registration information.

Registration may be accomplished in a variety of ways, including personal contact between advertiser 118 and the operators of central unit 102. However, in a preferred embodiment, registration is accomplished, as was described above, by use of an interactive interface.

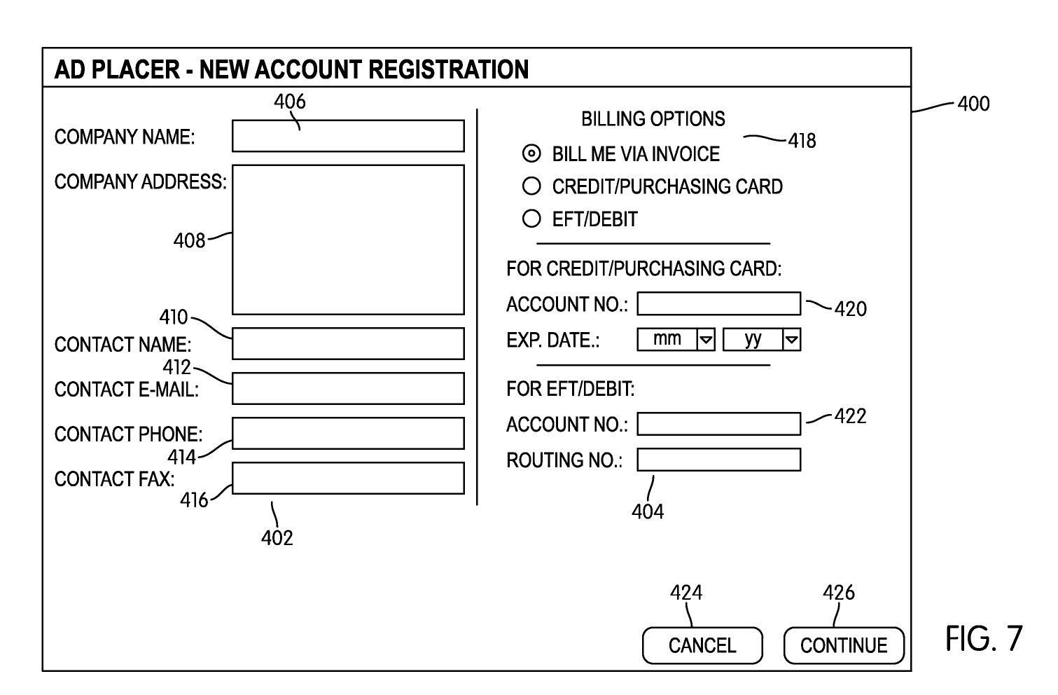

FIG. 7 is an illustration of a portion of an interactive interface, illustrating an exemplary registration screen, generally indicated at 400. Registration screen 400 includes a contact information area 402 and a billing information area 404 and allows advertiser to input contact information and billing information, thereby completing sub-steps 3040 and 3042.

As shown, content information area 402 includes fields for company name 406, company address 408, contact name 410, contact e-mail address 412, contact telephone number 414, and contact fax number 416. Billing information area 404 includes a billing option selector 418 that allows advertiser 118 to choose between paper invoice billing, payment by credit or purchasing card, and EFT/Debit payment. Any type of payment option may be offered by registration screen 400 and handled by central unit 102. Advertiser 118 may also enter information for multiple forms of payment, so that a particular form of payment can be selected for each transaction. At the bottom of registration screen 400 are a cancel button 424 that resets the form, and a continue button 426 that submits the information to central unit 102. Continue button 426 may be coupled to an error-checking routine that confirms that all necessary fields have been filled in.

Once advertiser 118 has registered with central unit 102 and provided payment information, advertiser 118 is free to perform the other steps of method 300, which involve providing advertising content and preferences, at another time. That is, the steps of method 300 need not be completed all at once.

Assuming that advertiser 118 has advertising content to place and preferences and requests to go with that content, step 304 continues with sub-steps 3044 and 3046, as illustrated in FIG. 6. In sub-steps 3044 and 3046, respectively, the advertiser provides advertising content and preferences to central unit 102. As with registration screen 400, the submission of content, preferences, and requests are preferably handled by an interactive interface. From a user standpoint, the actual data entry areas may be combined into a single entry screen or handled with multiple entry screens. In some cases, continue button 426 of registration screen 400 may lead directly to a content submission and preference entry screen.

Once sub-steps 3044 and 3046 are complete and central unit 102 has accepted the advertising content, preferences, and requests, central unit 102 performs step 306 of method 300, as illustrated in FIG. 5. As shown in FIG. 6, step 306 includes a number of sub-steps. Some of the sub-steps performed by central unit 102 may be interspersed with steps or sub-steps performed by advertiser 118, but for convenience, they are shown separately.

As shown in FIG. 6, the sub-steps performed by central unit 102 as part of step 306 of method 300 begin at sub-step 3060, in which central unit 102 receives, accepts and stores the registration and payment information submitted by advertiser 118. Following sub-step 3060, central unit 102 receives and accepts the advertising content, preferences and requests submitted by advertiser 118 in sub-step 3062.

Once the content has been received in step 3062, central unit 102 proceeds with sub-step 3064, in which the submitted advertising content is checked to make sure that it is compatible with the file formats used by remote systems 104 and, optionally, otherwise meets the standards required by central unit 102. If the advertising content is incompatible with the formats used by central unit 102 or there is some other problem, method 300 may continue with sub-step 3072, in which advertiser 118 is asked to re-submit the advertising content. If the advertising content is acceptable, method 300 continues with sub-step 3066, in which central unit 102 determines the price for placing the advertising content according to the selected preferences and requests, and collects payment from advertiser 118.

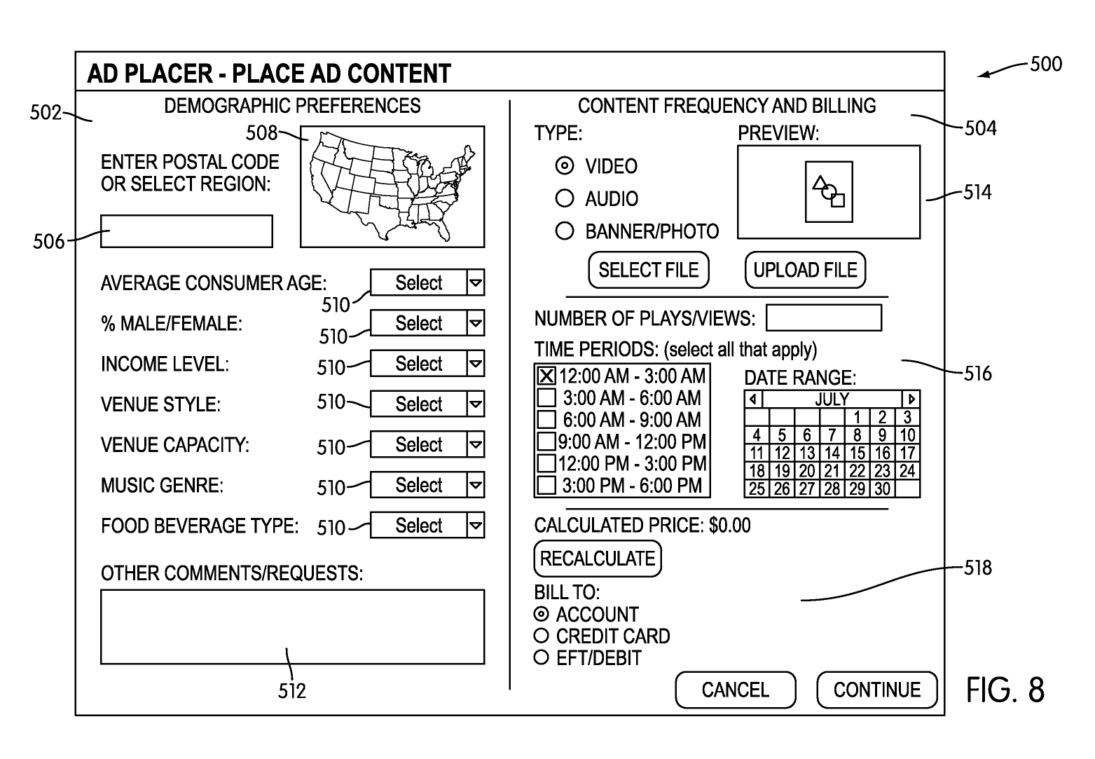

Once payment has been provided, central unit 102 selects appropriate remote systems 104 for advertising content placement in sub-step 3068, distributes the advertising content to selected remote systems 104 in sub-step 3070, and receives distribution information including verification from selected remote systems 104 that the advertising content has been played in sub-step 3074. The sequence of steps illustrated in FIG. 6 may be better understood with reference to FIGS. 8-10, schematic diagrams of portions of an interactive interface, illustrating exemplary interactive interface screens.

FIG. 8 is an illustration of an exemplary preference-entry screen, generally indicated at 500, which comprises one portion of an interactive interface that advertiser 118 would use to provide advertising content and preferences and requests related to that content. Preference-entry screen 500 is divided into two general areas to collect two different types of information. A first area 502 of preference-entry screen 500 is devoted to the entry of preferences and requests; a second area 504 of preference-entry screen 500 is devoted to the advertising content, the total number of plays or views of the advertising content, and the billing arrangements.

First area 502 provides a geographic selection portion 506 that allows the selection of the particular region or regions in which the advertising content is to be played or displayed. A region or regions may be selected using any type of region-identifying data. For example, particular states, provinces, or localities could be selected, as could particular postal codes and telephone area codes. In the illustrated embodiment, selection portion 506 allows geographic selection by entry of a postal code, a partial postal code, or a range of postal codes, or by clicking on a particular portion of an accompanying interactive map 508.

Preference-entry screen 500 also allows the entry of preferences and requests. Specifically, preference-entry screen 500 includes a number of selection boxes 510 that allow advertiser 118 to select desired ranges for male/female ratio, income level, venue style, venue capacity, and food/beverage type. Depending on the embodiment, other categories may also be included.

Some embodiments include provisions that allow advertisers to place advertisements based on music genre. In some cases, the owner or operator of the remote system provides information related to the predominant music genre of that particular venue. However, in preferred embodiments, the predominant music genre of songs requested or played at a certain venue is determined by tracking the actual music or songs that have been requested at that venue.

In some embodiments, a weighing system can be used, where songs are associated with a particular genre, the genres are associated with a numerical value, and the numerical value is used to determine or calculate the predominant music genre for that particular venue. This weighing system can be understood by considering the following example.

In one example of the weighing system, a numerical scale of 0 to 10 is used. Lower values are associated with music genres that are generally rhythmically slower and generally appeal to an older, more mature audience. While higher numbers are associated with music genres that are generally rhythmically faster and generally appeal to a younger audience. In this example:

50's music can be associated with 0,

swing music can be associated with 1,

blues music can be associated with 2,

country can be associated with 3,

soft rock can be associated with 4,

classic rock can be associated with 5,

hard rock can be associated with 6,

pop music can be associated with 7,

dance music can be associated with 8,

electronica or trance music can be associated with 9, and

hip hop/urban music can be associated with 10.

As songs are selected and played at a remote system, the songs, as well as their respective genres are memorialized or stored in some way by the remote system. The remote system can either immediately report the selected songs to central unit 102, or the remote system can send batches of stored songs at predetermined intervals, to central unit 102.

Eventually, central unit 102 receives this play list information and, in some embodiments, assigns a numerical genre weight to the venue associated with the remote unit. In one embodiment, the genre associated with each song is then associated with a particular numerical value. An example of these numerical genre values is given above. A numerical value or weight is then assigned to the venue associated with the remote system.

The numerical value or weight for the venue can be determined in a number of ways. Preferably, the numerical value or weight for the venue is associated with the predominant genre of music selected at that venue. In some embodiments, the numerical value associated with the genres of all of the songs played at a particular remote system is averaged. This average can serve as the numerical value or weight for that particular remote system and its associated venue. Other statistical or mathematical methods can also be used to determine the numerical value or weight for a particular venue. Some possible methods include: statistical or standard distribution analysis, root mean square analysis, use of the mean, median and/or mode, or any other desired analysis.

The analysis can also include provisions for determining that a certain venue lacks any clear, discernable or statistically significant pattern. In some cases, the kinds of music selected at a particular venue will vary greatly and the selection of music may be so random, that no meaningful pattern emerges. In some embodiments, the analysis may include provisions to observe these kinds of venues.

Using this system and method of determining a numerical value or weight associated with the predominant genre of music selected at a particular venue, advertisers can select appropriate markets or audiences for their communications. This method also helps to prevent human error, inaccuracies and subjective estimates in determining the predominant type of music selected at a particular venue.

Although the selection of particular ranges for desired demographic characteristics standardizes the input of data and is conducive to automatic handling and processing, embodiments of the application may allow advertiser 118 to specify preferences or requests by other means. For example, beneath the selection boxes 510, first area 502 provides a data-entry space 512 for entry of other, text-based comments and requests not covered by the selection boxes 510.

In selecting the music genre, selection box 510 may provide a drop down list of numbers, allowing the user to select one or more numbers. These numbers can be associated with the numerical value or weight associated with the predominant genre of music selected at a particular venue. Preferably, the user is provided information about the definition or meaning of the music genre numbers. This information can be provided during the user's interaction with preference-entry screen 500.

Second area 504 of preference-entry screen 500 provides a content selection area 514, a frequency selection area 516, and a billing selection area 518. Content selection area 514 allows advertiser 118 to select one or more advertising content files from the local system and upload them to central unit 102. Content selection area 514 also provides a preview of the advertising content once it is uploaded to central unit 102, as shown in FIG. 8. In preferred embodiments, central unit 102 is capable of accepting video, audio, animation, and photographs or other still images.

Any and all video, audio, and graphic formats may be accepted by central unit 102. Examples of suitable video formats include MPEG, AVI, QuickTime, HTML, Shockwave, and Flash. Examples of audio formats include WAV, MP3, MP4, AIFF, Ogg Vorbis, lossless and AAC. Examples of graphic formats include GIF, JPEG, PNG, BMP, PDF, and EPS. Typically, remote systems 104 would be configured to display a limited number of file formats. As described above, in order to avoid incompatibilities, central unit 102 may check the uploaded advertising content to determine if the content meets compatibility requirements. Central unit 102 may request resubmission if the advertising content does not meet certain requirements. In some embodiments, central unit 102 may convert the advertising content from the submitted format to a preferred format for distribution to remote systems 104.

Some elements of the checking steps may be encoded in routines performed on the computer system of advertiser 118 before submission. For example, a routine on the computer system of advertiser 118 (encoded, for example, as a JavaScript routine) could allow only certain formats to be uploaded.

Preferably, central unit 102 allows advertiser 118 to designate timing and frequency preferences and requests. These timing and frequency preferences and requests may describe such things as the total number of plays or views that are desired, the time periods during which the advertising content should be played or displayed, and the date or range of dates over which the content is to be played or displayed.

Beneath content selection area 514, second area 504, frequency selection area 514 allows advertiser 118 to select the time periods desired for play, as well as the dates or date ranges during which play is desired. In addition to general date ranges and frequencies, advertiser 118 may also submit preferences or requests that advertising be displayed during special events or at other non-periodic times.

Preferably, central unit 102 is also capable of arbitrating and/or calculating a price based on the number of preferences and requests, the type of preferences and requests, and the type of content, among other factors.

As shown in preference-entry screen 500 of FIG. 8, the price-calculating function in the illustrated embodiment is found in billing selection area 518. Central unit 102 may dynamically calculate a price as advertiser 118 selects options in first area 502. A re-calculate button 520 is also provided so that central unit 102 can be forced to re-calculate the calculated price if necessary. Billing selection area 518 also allows advertiser 118 to select between methods of payment entered using registration screen 400.

The price calculation methodology and algorithm used by central unit 102 may be of any type. For example, a particular price could be attached to each demographic characteristic selectable in first area 302, and central unit 102 could then sum the price for each selected demographic characteristic to determine the final price. Alternatively, pricing could be determined based on the total number of demographic preferences and requests that are submitted. The price calculation methodology and algorithm could also take into account such factors as the prevailing advertising prices in each particular geographic area or market and the nature of the advertiser 118. For example, discounts or preferred pricing arrangements may be given to a high-volume advertiser. Additionally, special pricing may apply if the advertiser's submitted preferences and requests pertain to display during a special event or other one-time occasion.

Preferably, once advertiser 118 provides the desired preferences or requests to central unit 102, central unit 102 responds by allowing advertiser 118 to confirm the selections and billing information before processing those selections. Typically, the name and type of advertising content, the selected preferences and requests, and the total cost are displayed.

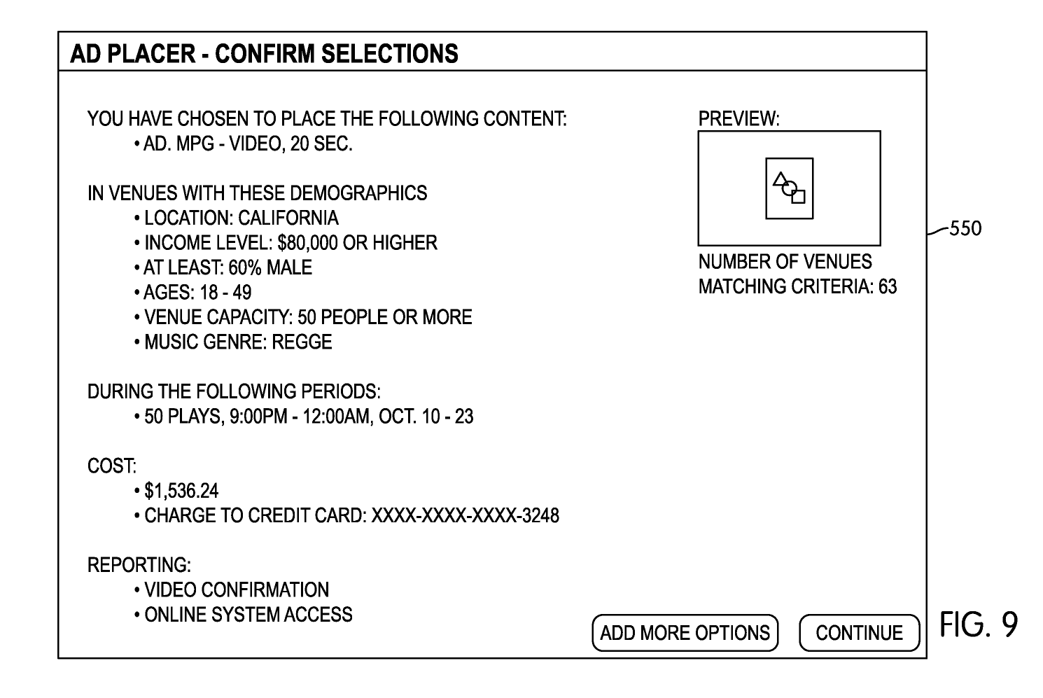

FIG. 9 is an illustration of a confirmation screen, generally indicated at 550. As illustrated, confirmation screen 550 displays the file name, type, and duration of the advertising content, as well as a preview of it. Confirmation screen 550 also displays the selected demographics, the time periods and days for play/display, and the total cost. In the illustrated example, advertiser 118 has chosen to display a 20 second video in California venues with a capacity of at least 50 people having a patronage that is at least 60% male, ages 18-49, in areas with median income of $80,000 per year or higher. Advertiser 118 has further chosen to have the video played a total of 50 times in the period of 9:00 PM to 12:00 AM from October 10-23. As illustrated, the total cost for playing this content with the specified preferences and requests is to be charged to a credit card number. Reporting is to include visual/video confirmation of play where that feature is available (i.e., in venues that include a video verification unit 1050).

Once advertiser 118 confirms the preferences and requests, the actual purchase transaction is handled. As was described above, central unit 102 may handle a variety of types of payment and purchase transactions in support of method 300. In many embodiments, payment may be handled automatically. In some embodiments, payment information could be directed to a third-party payment processing system that would then notify central unit 102 when costs were paid by advertiser 118.

Preferably, each time a piece of advertising content is played or displayed, the play or display is recorded so that distribution information can be reported back to central unit 102 and, ultimately, to advertiser 118. This may be done, for example by recording the time and date of play in a log file. However, in preferred embodiments that include video verification unit 1050, a picture or video may be taken of remote system 104 playing or displaying each piece of advertising content.

At regular intervals, as was illustrated and described with respect to sub-step 3072 of FIG. 6, remote systems 104 may transmit, and central unit 102 may receive various forms of information. In some embodiments, central unit 102 is updated with distribution and verification information. In some embodiments, this distribution and verification information can include log files related to the songs, advertisements, or other forms of multimedia information played by remote system 104. The distribution and verification information can also include photographs or video clips showing the submitted advertising content being played at certain predetermined venues at pre-selected times. Advertiser 118 may then access central unit 102 to view the verification information, as indicated in step 308 of method 300,

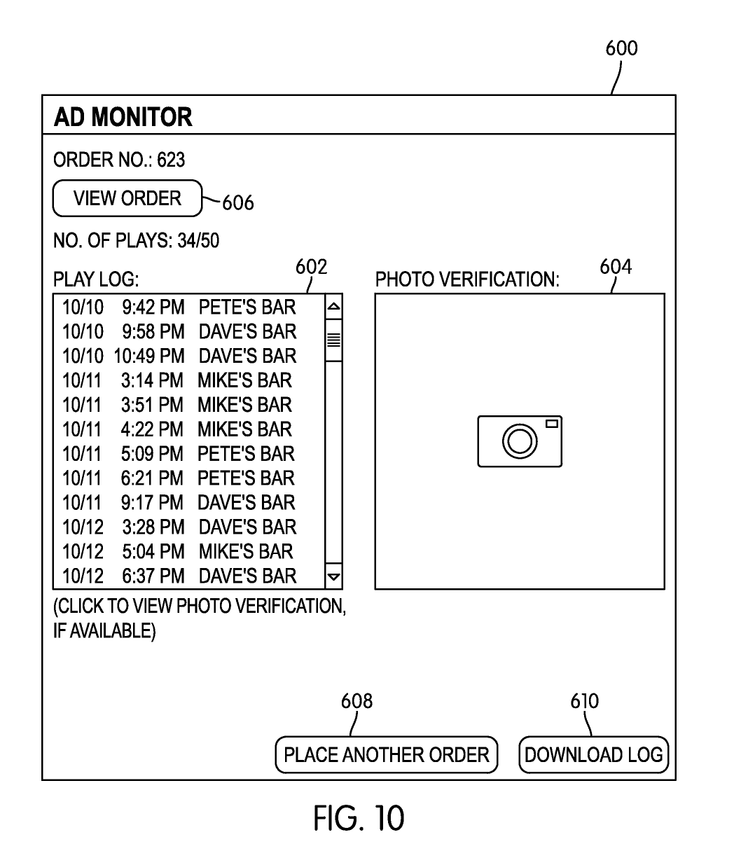

FIG. 10 is an illustration of a verification screen, generally indicated at 600, which advertiser 118 would reach after an appropriate login/identification process. Verification screen 600 includes a concatenated listing 602 of the log files of the various remote systems 104 and a photo-video verification section 604 that displays a verification photograph or video for a particular log entry, if a verification photograph is available for that entry. Another indicator on verification screen 600 indicates the current number of plays of the advertising content versus the requested number of plays. Buttons 606, 608, and 610 provide advertiser 118, respectively, with the opportunity to view the original order, place another order, or download the concatenated log file for further study. Depending on the embodiment, some or all venue identifying information in the log file (or other downloadable confirmation information) may be redacted so that advertiser 118 cannot access proprietary information on venues 105 that is gathered by the operator of central unit 102.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A method for distributing advertising content comprising the steps of:
receiving registration information from an advertiser;
receiving advertising content from the advertiser;
receiving at least one advertising preference from the advertiser; and
distributing the advertising content to at least one amusement device based on the advertising preferences.

2. The method according to claim 1, wherein the registration information is received using an interactive interface.

3. The method according to claim 2, wherein the interactive interface is a website.

4. The method according to claim 1, wherein the advertising content includes video.

5. The method according to claim 1, wherein the advertising content includes audio.

6. The method according to claim 1, wherein the advertising content includes a still image.

7. The method according to claim 1, wherein the advertising content includes animation.

8. The method according to claim 1, wherein the advertising preference is related to a geographic location.

9. The method according to claim 1, wherein the advertising preference is related to a demographic criteria.

10. The method according to claim 1, wherein the advertising preference is related to venue information.

11. A method for distributing advertising content comprising the steps of:
receiving an advertisement and at least one advertising preference from an advertiser;
distributing the advertisement to at least one amusement device in accordance with the advertising preference; and
receiving payment from the advertiser based on the distribution of the advertisement.

12. The method according to claim 11, wherein the payment is automatically collected.

13. The method according to claim 11, wherein the advertising preference selects multiple amusement devices to receive the advertisement.

14. The method according to claim 11, wherein a plurality of amusement devices are associated with a demographic criteria and an advertising preference is associated with the demographic criteria.

15. The method according to claim 11, wherein a plurality of amusement devices are associated with a geographic criteria and an advertising preference is associated with the demographic criteria.

16. A method for interacting with an advertiser comprising the steps of:
receiving registration information from the advertiser;
receiving advertisement distribution information from at least one amusement device;
providing access to an interactive interface; and
wherein the interactive interface includes advertisement distribution information received from the amusement device.

17. The method according to claim 16, wherein the advertisement distribution information includes a time when an advertisement associated with the advertiser was distributed.

18. The method according to claim 16, wherein the advertisement distribution information includes location information where an advertisement associated with the advertiser was distributed.

19. The method according to claim 16, wherein the advertisement distribution information includes frequency information related to a number of times when an advertisement associated with the advertiser was distributed.

20. The method according to claim 16, wherein the advertisement distribution information includes confirmation information related to an advertisement associated with the advertiser.

21. The method according to claim 20, wherein the confirmation information includes an image of the advertisement being distributed.

22. The method according to claim 20, wherein the confirmation information includes a video of the advertisement being distributed.

23. A method for distributing advertising content comprising the steps of:
receiving play list information from a remote system;
determining a predominant music genre for the play list;
receiving an advertisement from an advertiser;
receiving a distribution preference from the advertiser associated with a music genre; and
distributing the advertisement to at least one remote system based on the distribution preference and the predominant music genre for the play list.

24. The method according to claim 23, wherein a venue numerical value, assigned to a venue associated with the remote system, is determined using the predominant music genre of the play list.

25. The method according to claim 24, wherein songs of the play list have associated song genres, and wherein those song genres are assigned a song numerical value.

26. The method according to claim 25, wherein the song numerical value is used to determine the venue numerical value.

27. The method according to claim 24, wherein the venue numerical value is used to offer the advertiser a selection of possible music genres.
